(19) United States
(12) Patent Application Publication
(10) Pub. No.: US 2025/0313116 A1
(43) Pub. Date: Oct. 9, 2025

(54) SYSTEM AND METHOD FOR DYNAMIC CHARGING OF BATTERY DRIVEN VEHICLES AND A SWITCH ARRANGEMENT IN SUCH A SYSTEM

(71) Applicant: KEMPOWER OYJ, Lahti (FI)

(72) Inventors: Petri KORHONEN, Lahti (FI); Jarmo KURONEN, Lahti (FI)

(21) Appl. No.: 18/860,440

(22) PCT Filed: Apr. 25, 2023
(86) PCT No.: PCT/FI2023/050226

§ 371 Date: Oct. 25, 2024

(30) Foreign Application Priority Data
Apr. 26, 2022 (FI) 20225347

(51) Int. Cl. B60L 53/67; B60L 53/10; B60L 53/63; B60L 53/66

(52) U.S. Cl. CPC B60L 53/67; B60L 53/11; B60L 53/63; B60L 53/66

(57) ABSTRACT

The invention is concerned with a system for charging electric vehicles and comprises at least one power channel (1, 1′) for receiving power from a power source. Said at least one power channel (1, 1′) is connected to a dynamic module (3), which has two or more inputs connected to the power channels (1, 1′) and further it has one or more outputs. Said one or more outputs of the dynamic module (3) are connected to one or more charging outputs (4, 4′) for feeding power to vehicles that are connected to the charging outputs (4, 4′). The dynamic module (3) enables different configurations of connections between the power channels (1, 1′) and the charging outputs (4, 4′) via the dynamic module (3) by having connection components (5-13) in said connections to be opened or closed. Said different configurations of connections between the power channels (1, 1′) and the charging outputs (4, 4′) via the dynamic module (3) include configurations, wherein two or more power channels (1, 1′) are connected in series or in parallel, and/or there are both series-and parallel-connected power channels (1, 1′). The system further comprises a control module (2) for determination of the configuration of the connections and for performing the determined configurations by opening and closing the connection components (5-13) in said connections. The invention is also concerned with a method in such a system, in which method a vehicle to be charged is connected to a charging output (4, 4′) of the system. The vehicle sends identification information and information of the charging power needed to the control module (2) of the system. The control module (2) determines the configuration of the connections in the dynamic module on the basis of the received information and optional other parameters. The connections of the dynamic module (3) are steered by the control module (2) in accordance with the determined configuration of connections. The switch arrangement of the invention in such a system comprises connection components (5-13) in the connections that can be opened and closed thereby enabling connecting of a plurality of power channels (1, 1′) in series connection, in parallel connection or in series and in parallel connection. A part of the connection components (5-13) of the parallel connection part are placed so that they can be utilized for series connection by the logic of their control.

### TECHNICAL FIELD

The invention is concerned with a system and method of charging battery driven vehicles and further concerned with a switch arrangement for connections between power channels and charging outputs in a system for charging electric vehicles.

### BACKGROUND

An electric vehicle runs fully or partially on electricity and use an electric motor that is powered by a fuel cell or batteries.

The charging of battery driven vehicles takes place by using a charging output for charging the high-voltage battery of the electric vehicle and to precondition the vehicle.

In practice, the charging is usually performed by connecting a charging cable between the vehicle's charging socket and an electrical outlet giving alternating current or via a charging station.

The conventional way of rapid charging of battery driven vehicles is performed by using one charging device with one charging output.

Along with an increasing number of battery driven vehicles, there are nowadays also charging devices with more than one charging output. If there are several simultaneous charging outputs, there also has to be a corresponding number of mutually independent power channels in the charging system.

Such a charging system is presented in for instance US patent application 2013/0057209A1, which presents a charging system, wherein one or more power channels can be connected in parallel to the same charging output.

Vehicles of two different voltage ranges are marketed. Vehicles of a lower voltage range (wherein the battery voltage typically is lower than 500V) are usually passenger cars and vehicles of a higher voltage range (wherein the battery voltage typically is within the range of 500V-920V) are different kinds of commercial vehicles, such as e.g. buses and trucks.

Since the charging capacity and the charging speeds of passenger cars are increasing, also a part of those cars are going for the higher voltage range, since the amount of charging current has been increased for shortening the charging time of passenger cars and for increasing the charging power. In the future, also the voltage of the charging will be increased in order to a achieve a higher charging power.

There is therefore an increasing need for a solution with which the same charging output can be used for charging vehicles of both voltage ranges. Known charging systems either have separate charging outputs for the two voltage ranges or then there is a voltage range exchanger built in one charging system. Systems with such exchangers have one output and there is no possibility for scaling the charging power.

Furthermore, known charging systems are nowadays required to have a wide power range in addition to a broad voltage range. These requirements are a consequence of that different types of vehicles with different charging power demands are charged with the same charging system.

If the charging system consists of several charging outputs and of a centered power unit, from which the required power is fed to each charging output, a design in accordance with the highest possible power results in a power unit that is unfavorably big and is thus not optimal for a provider of charging services.

The invention solves the above problems of prior art by enabling an optimal design of a charging station for maximum power within an extensive voltage range.

### SUMMARY

The system of the invention for charging electric vehicles comprises at least one power channel for receiving power from a power source. Said at least one power channel is connected to a dynamic module, which has two or more inputs connected to the power channels and further it has one or more outputs. Said one or more outputs of the dynamic module are connected to one or more charging outputs for feeding power to vehicles that are connected to the charging outputs. The dynamic module enables different configurations of connections between the power channels and the charging outputs via the dynamic module by having connection components in said connections to be opened or closed. Said different configurations of connections between the power channels and the charging outputs via the dynamic module include configurations, wherein two or more power channels are connected in series or in parallel, and/or there are both series-and parallel-connected power channels. The system further comprises a control module for determination of the configuration of the connections and for performing the determined configurations by opening and closing the connection components in said connections.

The method of the invention for charging vehicles in the system comprises connecting a vehicle to be charged to a charging output of the system. The vehicle sends identification information and information of the charging power needed to the control module of the system. The control module determines the configuration of the connections in the dynamic module on the basis of the received information and optional other parameters.

The connections of the dynamic module are steered by the control module in accordance with the determined configuration of connections.

The switch arrangement of the invention, for connections between power channels and charging outputs in a system for charging electric vehicles, comprises connection components in the connections that can be opened and closed thereby enabling connecting of a plurality of power channels in series connection, in parallel connection or in series and in parallel connection. A part of the connection components of the parallel connection part are placed so that they can be utilized for series connection by the logic of their control.

The preferable embodiments of the invention have the characteristics of the subclaims.

The series-connected and/or parallel-connected power channels can for example be added to or released from any charging output during charging along with a changing power need of one or more vehicles or along with released charging capacity from other charging outputs.

The system works with a high charging voltage range, a low charging voltage range, or simultaneously with a high charging voltage range and a low charging voltage range. At least some of the individual charging outputs can have mutually different charging voltage ranges when the system works simultaneously with a high charging voltage range and a low charging voltage range.

Two or more of the charging outputs can have a mutually different number of series- and/or parallel-connected power channel pairs connected thereto via the dynamic module.

The control module determines the configuration of the connections on the basis of the charging power required by the vehicle and the maximal battery voltage and the charging conditions. The control module steers, via the dynamic module, to each charging output, a charging power, which is in accordance with the charging capacity provided by the system, and/or is requested by the vehicle. Furthermore, the control module steers, via the dynamic module, to each charging output, a charging power, which is optimized in accordance with the charging conditions and/or on the basis of the voltage range and/or power range of the vehicles to be charged. The control module can also determine the configuration of the connections on the basis of further charging conditions. The control module can also make changes in the configuration during charging when an additional vehicle is connected to a charging output or is decoupled from a charging output. Furthermore, the control module can make changes in the configuration during charging if the power need of the vehicle changes or if charging capacity is released from one or more charging outputs. The changes in the configuration can consist of changing between parallel connecting and series connecting power channels.

The determination of the configuration of the connections includes the number of series- and/or parallel-connected power channels. The connection components used for parallel connected power channels can be made use of for series connection.

The object of the invention is to optimize the design of a charging system with power channels when it is required to have a high maximal power with a low charging voltage as well as a high maximal charging voltage in the charging system. The invention results in an advantageous design of the charging system especially when the maximal charging power is high or when the charging system contains several charging outputs.

A further object of the invention is to optimize the use of the charging system so that each vehicle being charged gets its charging power according to injectability within the limits of the power feed or capacity of the charging system.

A dynamic charging of electric battery driven vehicles is achieved in the invention by making use of series-and parallel connections of power channels. The charging system of the invention consists of one or more charging outputs. The design is performed by an inventive combination of connection components and connecting lines in the charging system.

With power channel is here meant a means to transfer current at a certain voltage range. A power channel consists of a positive pole and a negative pole and can be controlled independently. A power channel can include means for AC/DC conversion or means for DC current/voltage manipulation. In practice, two power channels maybe enclosed or housed in a sc. power unit. Thus, one power unit consist of two power channels, which are connected in series or in parallel.

The charging system of the invention comprises at least one power unit with two power channels, a controller, a dynamic module, and one or more charging outputs from which the vehicles get the power. The charging outputs are in practice charging cables with suitable plugs to be connected to the vehicle. All these functional units can be placed in a common housing or in separate housings.

The power is transferred from the power channels of the power units and further through the dynamic module to the charging outputs. The power channels can be controlled independently by the control module. The number of power channels can vary in the system but there are at least two of them since each power unit consists of two power channels. There can not be more simultaneous charging events in the system than there are power channels. So, the maximal number of simultaneous charging events correspond to the number of power channels.

The power channels are controlled independently for feeding charging power via the dynamic module to the charging outputs and each power channel can be separately connected to a corresponding input of the dynamic module. The outputs of the dynamic module are correspondingly connected to separate charging outputs.

When a vehicle is connected to a charging output, the information of the charging power required by the vehicle and the maximum battery voltage is obtained on the basis of a communication between the vehicle and a control module in the charging system. The charging power required by the vehicle and the maximal battery voltage are informed from the vehicle to the control module of the charging system. The control module has a built-in control logic of the charging system, which takes the charging conditions, the vehicles connected to the charging system, and the order of priority defined for different groups of vehicles into consideration. The charging conditions include conditions or factors that have an influence on the charging event. Such conditions or factors are e.g. the characteristics or capacity of the feeding electric connection, the ambient temperature, road conditions, customer preference group of vehicles to be charged, vehicle type, car brand, car model, historical information of usage data of the charging station in question or corresponding data from several charging stations.

On the basis of this information, the control module steers the dynamic module and each charging channel transfers a charging power, which is in accordance with the charging capacity provided by the system, and/or is requested by the vehicle. The control module also determines whether the power channels from which the power is transferred to the charging outputs are to be connected in series and/or in parallel.

The control logic of the control module steers the charging system to use the charging capacity as efficiently as possible.

The power channels are connected to the inputs of the dynamic module. The control module steers the dynamic module in such a way that the power channels of the power units connected to the dynamic module are connected in series or in parallel or both in series and parallel separately to each charging output in accordance with desired maximum voltage or maximum power. Depending on the desired charging power, there can be more than one power channel in parallel. High voltage vehicles and low voltage vehicles can be charged at the same time in the same charging system. A parallel connection of the power channels enables a bigger charging current than a series connection. Correspondingly, a higher charging voltage can be achieved with a series connection for vehicles with a higher battery voltage. Parallel connection of series connected power channels increase charging power.

Additional power channels can be connected to any charging output either in series or in parallel or be decoupled from any charging output during charging for example if the power need of the vehicle changes or if charging capacity is released from one or more other charging outputs.

The operation of the dynamic charging system of the invention that works within an extensive voltage range is optimized on the basis of the charging conditions, the power range of the vehicles to be charged and/or on the basis of voltage range.

One or more power channels can be decoupled during a charging. Such a decoupling is preferably performed by decreasing the charging power or current available for a vehicle under charging, by decreasing, accordingly, the current from the power channel in question to zero, and, accordingly, to increase the current of the other power channels, so that the charging current fed to the vehicle remains unchanged in accordance with the power capacity required for the vehicle. The power channel can be detached from the charging output when the current of the power channel to be decoupled has been decreased to zero. The decoupled power channel can then be coupled to another vehicle to optimize the capacity usage of the system.

A connection of a power channel during a charging event can in a corresponding way be performed by increasing the output voltage of the power channel to correspond to the battery voltage of the vehicle that is connected to the charging output. When the voltage has been regulated, the power channel is connected to the charging output in question via the dynamic module. Thereafter, the maximal available charging power that corresponds to the new situation can be informed to the vehicle. The vehicle might then request additional charging power from the charging system, whereby the charging system delivers the requested charging power.

One or more power channels can in the described way be decoupled from and connected to another charging output.

The priority order of the charging can be stored in the form of a pre-defined prioritizing logic either in a back-end system or directly in the charging system. The back-end system can support back-office applications and can be used as part of corporate management and user input can be obtained and gathering input can be gathered from other systems to provide responsive output. When a new user arrives and identifies himself, whereby either the user or the vehicle is identified, the prioritizing logic of the client in question is selected.

If no identification takes place, the prioritizing logic is based on the capacity of the charging system and/or predefined prioritizing logic.

After the identification of the vehicle and change of parameters, the control logic of the charging system (which can be situated in the control module or in a remote computer) selects an optimal connection of power channels. Preferably, if the maximal charging voltage of the vehicle to be charged is ≤500V, and the charging conditions are met, the power channels are connected in parallel to the charging output in question. When the maximum charging voltage of the vehicle to be charged is >500V, and the charging conditions are met, two power channels are connected in series to the charging output in question.

Parallel connection and series connection require different connection topologies and connection logics. In the developed dynamic module, a part of the connection components of the parallel connection part are utilized for series connection by changing the logic of their control when they are used in series connection. This decreases the number of connection components switches needed compared to known solutions.

In known dynamic systems one or more power channels can be connected in parallel to the same charging output. In the system of the invention, there can be 1−n series connected power channels connected to the same charging output. In some embodiments, there can, in the same charging system, be some of the charging outputs that have power channels connected to them in series, some of the charging outputs that have power channels connected to it in parallel, and some of the charging outputs that have power channels connected to it in parallel and in series.

Thus, an optimal charging of vehicles of two different ranges of charging voltage (for example 500V and 800V) can be performed with the same charging system.

Prior art devices that e.g. have voltage range exchangers built in one charging system have only one output and do not enable a scaling of the charging power to be suitable by parallel connection of power sources. Neither is it possible to have many separate charging outputs in known charging systems of extensive voltage ranges.

In the system of the invention, it is possible to dynamically share the charging capacity (charging power) according to use situation or charging conditions among different charging outputs.

The developed system of the invention enables a connection of several charging channels to the same charging output in such a way that an optimum amount of charging capacity and charging voltage can be steered to any charging output according to the need of the vehicle connected thereto and charging conditions. The capacity to the different charging outputs can also be changed during charging when the overall charging situation changes. The charging situation can change e.g. in the end of an ongoing charging or when a new vehicle connects to a charging output or is released from a charging output.

Known systems do not allow a change of electrical configuration of connection during an unfinished charging. Neither has it been possible to charge vehicles of different voltage ranges by using an optimum charging capacity in the same charging output.

### FIGURES

FIG. 1 is an architecture view of the functional parts of the charging system of the invention

FIG. 2 presents a switch arrangement of the dynamic module of the system of the invention

FIG. 3 is a flow chart of an embodiment example of the invention

### DETAILED DESCRIPTION

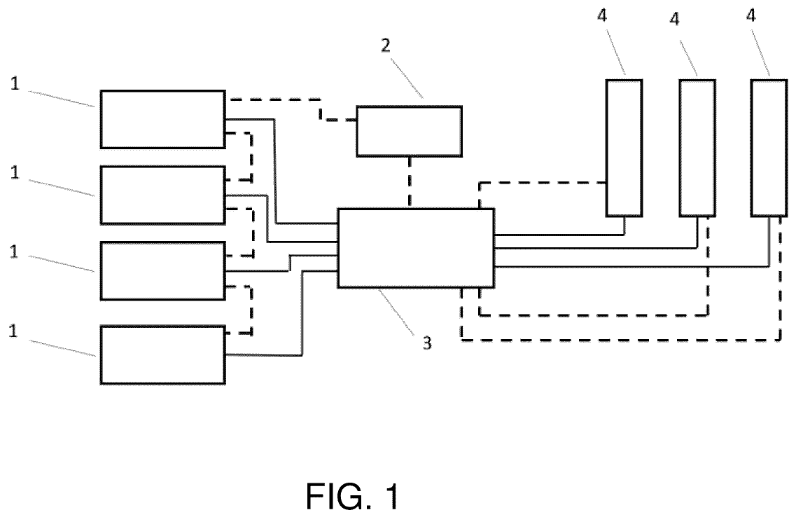

FIG. 1 is an architecture view of the functional parts of the charging system of the invention.

The charging system of the invention has two or more power channels 1 housed in a power unit. Four power channels are illustrated in FIG. 1. The function and control of the power channels are independent of each other.

Alternating current (ac) is fed from the electric network into the power channels and direct current (dc), which is required by the vehicles to be charged, are fed from the outputs of the power channels to a dynamic module 3. Thus, the power channels have alternating Current, AC, to Direct Current, DC, converters for converting the alternating current to direct current. Each power channel might alone generate the power needed for the charging.

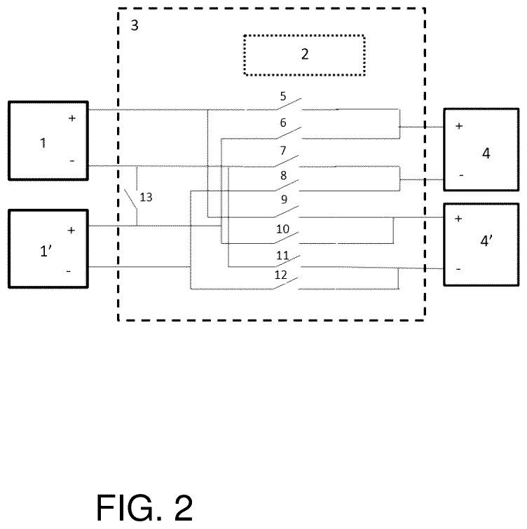

It is pointed out that in FIG. 1, the outputs of the power channels have been presented with one line only as well as the inputs to the dynamic module 3. Thus, one line is of illustrative reasons meant to present an output for a power channel 1. This can be seen more in detail in FIG. 2.

The charging system also includes said dynamic module 3. Each power channel is connected separately to inputs of the dynamic module 3. The dynamic module 3 has connection components, such as mechanical relays (see FIG. 2), transistors, or other semiconductors, mechanical switches, pneumatically steered switches or the like, by means of which power can be steered to different charging outputs 4. It is pointed out that in FIG. 1, the connections via which the power is steered to different charging outputs of the power channels have been presented with one line only, of illustrative reasons. The power can, however, be transferred both to a positive pole of a certain charging output or to a negative pole, which is seen more in detail in FIG. 2.

Any power channel that is connected to an input of the dynamic module 3 can be connected to any charging output 4 via the connecting components in the dynamic module 3 by controlling the decoupling and coupling of these connection components. The dynamic module 3 can have a different number of inputs than outputs.

The control logic of the dynamic module 3 can be inside the dynamic module 3 or be centered in a control module 2 of the charging system or in a remote computer.

There are at least two inputs in the dynamic module 3, whereby it is possible to connect two power channels in series. There is at least one output in the dynamic module 3, whereby the number of outputs correspond to the number of charging outputs 4 needed. The charging system has one or more charging outputs 4, to which the power channels of the power units are connected via and by the dynamic module 3 according to need.

The charging system of FIG. 1 also has a control module 2, which controls the function of the whole charging system. The control module 2 receives the information of the vehicle's request of charging capacity and the maximum battery voltage from the vehicle through the charging output 4. Other parameters for controlling the function is stored in a database in the control module 2 or in a remote computer.

In one embodiment, the power channels are connected in series, but they can be connected in other ways as well. An example of an other way is a sc. star connection (Y connection), wherein all control takes place in the control module 2. The dashed lines illustrate bidirectional communication meaning that the information can proceed in both directions. Thus, the control module 2 controls the power channels 1, the dynamic module 3, and the charging outputs 4. The charging outputs 4 communicate with the vehicle and forwards information of the capacity of the vehicle etc. to the control module 2, which in FIG. 2 takes place via the dynamic module 3 but could be directly forwarded to the control module 2.

The control module 2 uses different parameters that control the function of the charging system in order to calculate how much charging capacity is to be connected to a charging output 4 and by means of which configuration. Parameters that control the function of the charging system can for example include the situation of vehicles being in the other charging outputs of the same charging system, the available charging capacity, the order of priority defined for different groups of vehicles into consideration, customer preference group of vehicles to be charged, the ambient conditions, such as temperature, time etc, road conditions, historical information of usage data of the charging station in question or corresponding data from several charging stations, the type of vehicle to be charged (such as a bus, taxi or normal private car etc), the charging situation of the battery of the car etc.

The needed connection (in series or in parallel) of the power channels through the dynamic module and further to the charging outputs and the needed charging capacity (the number of power channels to be connected in parallel) in question are determined on the basis of request.

The control module 2 can for example compare the information (such as the battery voltage of the vehicle, the charging state of the battery, the maximum charging current, type of vehicle, type of client etc.) obtained from the vehicle in the hand shaking phase of the charging event to the available free charging capacity, and, by taking the ambient temperature into consideration, end up to perform the charging by means of a parallel connection between two power channels, even if a series connection between two or more power channels would be a more advantageous charging method when no other parameters that influence on the system are taken into consideration. There can for example be two power channels in series and also two or more power channels in parallel in the same charging output in order to achieve a sufficient charging power.

There can be one or more charging outputs 4 connected to the charging system. The operation of the invention is especially advantageous in those cases, wherein the number of charging outputs 4 in the same charging system is more than two.

It is also possible that two or more parallel connected power channels are connected for a vehicle for which a series connection would be a more advantageous alternative because of the situation in the other charging outputs of the system. This can for instance be performed in a situation, wherein almost all available charging capacity is occupied. In such a situation, a change into series connected power channels can be made during an unfinished charging of the vehicle in question in accordance with the principle described herein.

In its simplest form, if the rest of the system does not cause any restrictions, the choice between series/parallel connection is made on the basis of the battery voltage of the vehicle to be charged. Primarily, when the desired value of the battery voltage is more than 500V, series connection is chosen. A different choice can, however, be made on the basis of other parameters that influence on the logic of choice.

The above mentioned functional parts 1-4 of the charging system can physically be situated in the same common unit or then can be spread out among many separate units or modules. The control module 2 can be a physical unit or an electronic card in the charging system or it can consist of mere operation logic realized by software in the cloud or it can be a combination of both these.

In its simplest form, the dynamic unit 3 contains for example a relay matrix. There can be other connection components than relays, but preferably electromechanical relays or semiconductor switches. Any input of the dynamic unit can be connected to any output by means of the relay matrix. Thus, one or more power channels can be connected to an individual output of the dynamic system by means of the relays in the relay matrix.

An additional relay 13 added for and between each power channel pair in the dynamic unit (see FIG. 2), together with a suitable control of the relays in the relay matrix, makes it possible to connect two power channels in series to any charging output. This also enables a connection of several power channels in series to any charging output. This also enables a connection of several power channel pairs, which are connected in parallel, to the same charging output.

FIG. 2 presents the relay matrix 5-12 of the dynamic module 3 as well as the operation principle of the additional relay 13 added for series connection. The control logic steering the dynamic is performed by the control module 2, which can be situated in the dynamic module 3 or in a separate unit as in FIG. 1 or in some other unit of the system or in a remote computer.

In FIG. 2, only one additional relay 13 is shown as an example. There can be several additional relays to enable series connection between more power channels. In FIG. 1, the outputs of two power channels were presented with one line of illustrative reasons. This applies also for the inputs to the dynamic module 3. FIG. 2 is a more detailed view in this respect, wherein the outputs of the power channels, each consisting of a positive pole and a negative pole, have been presented with two lines. In a corresponding way, the inputs for power transfer of the charging outputs are also presented with two lines.

At least two power channels are connected to inputs of the dynamic module 3.

Any power channel 1,1′ can be connected via the relays 5-12 of the dynamic module 3 to any charging output 4, 4′. As the power channel consist of a positive pole and a negative pole, the connection takes place so that the positive pole of a power channel is connected to the positive pole of a charging output, and correspondingly, so that the negative pole of a power channel is connected to the negative pole of a charging output.

If for example power channel 1 is to be connected to charging output 4, relays 5, 7 are closed. If also power channel 1′ is desired to be connected to the same charging output 4, then also relays 6, 8 are closed.

When an additional relay 13 is added to the system and the control logic of relays 5-12 are changed, two power channels can be connected in series to the same charging output 4 or 4′ in another way. For example, at charging output 4, it means that relays 5, 8, and 13 are closed. This principle can be extended in a corresponding way for more power channels and charging outputs.

FIG. 2 thus shows relays as the connection components of channels between two power channels 1, 1′ and two charging outputs 4, 4′. The connection components are in the dynamic module 3 and can consist of e.g. electro-mechanical relays. There can be more power channels and charging outputs connected according to the same principle with connection components between those.

In a system with simultaneous series and parallel connected power channels more than two power channel pairs are needed. When there are more than two power channel pairs, they have connection components in a corresponding way as in FIG. 2. Then, e.g. the two first power channels 1, 1′ can be connected in series to charging output 4 and the following ones can be parallel connected to charging output 4′.

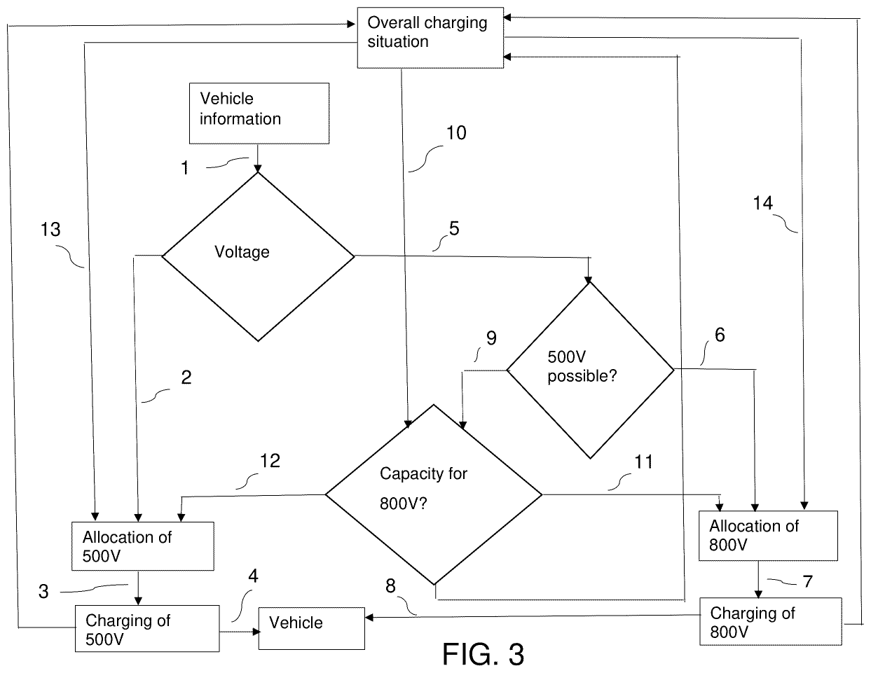

FIG. 3 is a flow chart of an embodiment example of the invention. The flow chart describes the allocation of 500V or 800V charging according to which the power channels are connected to the charging outputs 4, 4′ by means of opening or closing the relays of the dynamic module according to FIG. 2.

It is in this embodiment example assumed that a vehicle arrives for charging to a charging output.

The vehicle performs a handshake with the charging system, whereby parameters for the charging is informed in step 1, such as about the charging request. On the basis of this information, the charging system can make decisions of connections needed for the power channels for providing the needed charging power.

It is then determined whether the vehicle requests a 500V or 800V charging.

In case of a requested charging of 500V identified and communicated according to step 2, a power allocation for a 500V charging can directly be allocated according to step 3 and a 500V charging takes place in step 4.

In case of a requested charging of 800V identified and communicated according to step 5, it is after that determined whether a 500V charging is possible. This could be the case with modern passenger cars.

If it is determined that a 500V charging is not possible, i.e. if only a 800V charging is possible (because of vehicle requirements) in step 6, then a 800V charging is allocated according to step 7 and a 800V charging takes place in step 8.

If it is determined that also a 500V charging is possible even if a 800V charging is requested by the vehicle in step 9, then the overall situation of the charging conditions are taken into account.

The power that is possible to be allocated depends on the overall situation of the charging conditions, such as the number of other vehicles for simultaneous charging, weather and other environmental conditions, electrical network limitations etc. as mentioned earlier. The amount of power requested by the vehicle is also taken into account even if not necessarily allocated. Information of the overall situation of the charging conditions is informed by the program according to step 10.

If it is determined that there in fact is capacity for an allocation of a 800V charging according to step 11, then a 800V charging is allocated according to step 7 and a 800V charging takes place in step 8.

If it is determined that there is not capacity for an allocation of a 800V charging according to step 11, then a 500V charging is allocated according to step 3 and a 500V charging takes place in step 4.

The overall charge situation is continuously checked and if the charging conditions change, upon e.g. a departure of a car, an arrival of a car, and when the charging power for existing vehicles at charging changes, some external parameter changes (such as at an occurrence of a network power limitation, or other condition) then the power allocation may even change for existing vehicles if required by the information provided according to steps 13 and 14.

In that way, the system of the invention continuously optimizes the allocation of power and overall charging.

1. A system for charging electric vehicles, whereby the system comprises:
at least one two power channels for receiving power from a power source, said at least one two power channel channels being connected to a dynamic module,
the dynamic module having two or more inputs connected to the at least two power channels and further having one or more outputs,
said one or more outputs of the dynamic module being connected to one or more charging outputs,
the one or more charging outputs for feeding power to vehicles connected to the one or more charging outputs,
wherein the dynamic module enables different configurations of connections between the at least two power channels and the one or more charging outputs by having connection components in said connections in opened configurations or closed configurations, wherein said different configurations of connections between the at least two power channels and the one or more charging outputs via the dynamic module include configurations wherein the at least two power channels are connected in series or in parallel, and/or the at least two power channels are both series-connected and parallel-connected, wherein the connection components used for parallel-connected power channels can be made to be for series-connected power channels, and
a control module determining the configuration of the connections and for performing the determined configurations by opening and closing the connection components in said connections.

2. The system of claim 1, wherein series-connected and/or parallel-connected power channels can be added to or released from any one of the one or more charging outputs during charging along with a changing power need of one or more vehicles or along with released charging capacity from any other charging outputs of the one or more charging outputs.

3. The system of claim 1, wherein the system works with a high charging voltage range, a low charging voltage range, or simultaneously with a high charging voltage range and a low charging voltage range.

4. The system of claim 3, wherein at least one of the one or more charging outputs have mutually different charging voltage ranges when the system works simultaneously with a high charging voltage range and a low charging voltage range.

5. The system of any of claim 1, wherein there are at least two charging outputs, and the at least two charging outputs have a mutually different number of series-connected and/or parallel-connected power channel pairs connected thereto via the dynamic module.

6. The system of claim 1, wherein each of the at least two power channels are controlled independently for feeding charging power via the dynamic module to the charging outputs.

7. The system of claim 1, wherein each of the at least two power channels is separately connected to a corresponding input of the dynamic module.

8. The system of claim 1, wherein the control module determines the configuration of the connections on the basis of the charging power required by the vehicle and a maximal battery voltage of a battery of the vehicle connected to a charging output of the at least one charging output and the charging conditions.

9. The system of any of claim 1, wherein the control module steers, via the dynamic module, to each of the one or more charging output outputs, a charging power, which is in accordance with a charging capacity provided by the system, and/or is requested by the vehicles to be charged.

10. The system of any of claim 1, wherein the control module steers, via the dynamic module, to each of the one or more charging outputs, a charging power, which is optimized in accordance with charging conditions and/or on the basis of a voltage range and/or power range of the vehicles to be charged.

11. The system of claim 1, wherein the determination of the configuration of the connections includes the number of series-connected and/or parallel-connected power channels.

12. A method for charging vehicles in by a system comprising at least two power channels, a control module, one or more charging outputs, and a dynamic module comprising connections between the at two power channels and the one or more charging outputs, the method comprising the steps of:
a) connecting a vehicle to be charged to a charging output of the one or more charging outputs,
b) receiving from the vehicle to be charged, by the control module, identification information and information of the charging power need,
c) determining, by the control module, a configuration of the connections in the dynamic module on the basis of the received information and optional other parameters, and
d) steering the connections of the dynamic module by the control module in accordance with the determined configuration of connections.

13. The method of claim 12, whereby comprising, determining by the control module configuration of the connections of the dynamic module on the basis of further charging conditions.

14. The method of claim 12, comprising making, by the control module, changes in the configuration during charging of the vehicle when an additional vehicle is connected to a an additional charging output or is when the vehicle is decoupled from a the charging output.

15. The method of 13, comprising making, by the control module, changes in the configuration during charging of the vehicle if the power need of the vehicle changes or if charging capacity is released from the one or more charging outputs.

16. The method of claim 14, wherein the making changes in the configuration consist consists of changing between parallel-connected and series-connected power channels.

17. The method of claim 16, comprising using the connection components used for connecting power channels in parallel also for connecting power channels in series.

18. A switch arrangement for connections between a plurality of power channels and charging outputs in a system for charging electric vehicles, the switch arrangement comprising:
connection components in the connections that can be opened and closed thereby enabling connecting the plurality of power channels in a series connection, in a parallel connection, or in the series connection and in the parallel connection; and wherein a part of the connection components of the parallel connection part are placed so that they can be utilized for series connection by the logic of their control.
